(19) United States
(12) Patent Application Publication
(10) Pub. No.: US 2024/0424845 A1
(43) Pub. Date: Dec. 26, 2024

(54) CONVERTIBLE TRAILER

(71) Applicant: Insight Products Inc., Logan, UT (US)

(72) Inventors: John Wilson, Smithfield, UT (US); Luke Stevenson, Sandy, UT (US); Wade Pierson, Logan, UT (US); Bryce Seeholzer, Hyrum, UT (US)

(21) Appl. No.: 18/739,187

(22) Filed: Jun. 10, 2024

Related U.S. Application Data
(60) Provisional application No. 63/507,405, filed on Jun. 9, 2023.

(51) Int. Cl. B60D 1/58; B60D 1/01; B60D 1/36

(52) U.S. Cl. CPC B60D 1/58; B60D 1/01; B60D 1/36

(57) ABSTRACT

A convertible, modular trailer includes a flatbed base including at least two wheels, a trailer tongue, and a plurality of attachment channels. The plurality of attachment channels have respective openings with a cross-section adapted to a particular coupling geometry to couple the flatbed base to various modules. The various modules include: a detachable tub component including a set of tub couplings on a bottom surface of the detachable tub component, where the set of tub couplings have the particular coupling geometry, and a detachable tower component including a horizontal bridge support, at least one upright support leg, and a tower coupling at the base of the upright support leg, where the tower coupling has the particular coupling geometry.

### RELATED APPLICATIONS

This application claims benefit to U.S. Provisional Patent Application Ser. No. 63/507,405, filed Jun. 9, 2023, which is incorporated by reference herein in its entirety.

### BACKGROUND

The present disclosure relates in general to the field of towable vehicle trailers, and more specifically, to modular trailers.

For centuries, trailers, carts, and other wheeled apparatus have been developed and used to allow an animal or vehicle to tow cargo of the trailer or cart. Modern trailers include trailers of various shapes and sizes, often adapted to the type of vehicle that is to pull the trailer (e.g., with different trailer features being adopted in trailers when the trailer is configured to be towed by a motorcycle or all-terrain vehicle (ATV), car, truck, or tractors) or the particular cargo (e.g., livestock, vehicles, boxes, etc.) that is to be towed using the trailer. In many cases, trailers are purpose built for a specific purpose, such as a trailer for towing a boat, and owners may have multiple different trailers for multiple different purposes and/or cargo types, etc.

### BRIEF DESCRIPTION OF THE DRAWINGS

FIG. 1 illustrates an example modular convertible trailer system in a first example orientation.

FIG. 2 illustrates the example modular convertible trailer system of FIG. 1 in a different, second example orientation.

FIG. 3 illustrates the example modular convertible trailer system of FIGS. 1 and 2 in a different, third example orientation.

FIG. 4 illustrates the example modular convertible trailer system of FIGS. 1-3 in a different, fourth example orientation.

FIG. 5 is a detailed view of an example attachment channel and module coupling in accordance with one implementation of a modular convertible trailer system.

FIG. 6 is another view of an example attachment channel and module coupling in accordance with one implementation of a modular convertible trailer system.

FIG. 7 illustrates an example tower module included in an example modular convertible trailer system.

FIG. 8 illustrates a view of a fender element of an example modular convertible trailer.

FIG. 9 illustrates a view of a bed element of an example modular convertible trailer.

FIG. 10 is a photographic image showing the conversion of an example modular convertible trailer.

FIG. 11A shows a photograph illustrating a first example use of an example modular convertible trailer system.

FIG. 11B shows a photograph illustrating a second example use of an example modular convertible trailer system.

FIG. 11C shows a photograph illustrating a third example use of an example modular convertible trailer system.

Like reference numbers and designations in the various drawings indicate like elements.

### DETAILED DESCRIPTION

An improved trailer is provided and described in the following figures and disclosure. A variety of different trailers are currently manufactured and sold for a variety of different uses and applications. It is not unusual for a person or entity to own multiple different trailers, each constructed for its particular, specific purpose. For instance, trailers may include trailers used for hauling materials within an agricultural, educational, recreational, or industrial setting. Trailers may be used to assist in transporting a vehicle (e.g., a utility terrain vehicle (e.g., a side-by-side, ATV, etc.), a motorcycle or bicycle, watercraft, light aircraft, and other examples. Some trailers may have ramps, some may have walled perimeters, others may have flat-bed orientations with one or more open walls, among other configurations. While some trailers may be designed to accommodate multiple uses, traditional trailers are ultimately limited in their flexibility and adaptiveness by their constructions and physical features, which are typically solid and permanent in nature (e.g., to reinforce the trailer with structural integrity to handle the forces and loads placed upon them). Ultimately, some users may acquire multiple different trailers in order to handle all of the different workloads and applications they may have, for which a trailer could be useful.

In an improved design, a modular trailer is provided, which provides a flexible towing platform that allows a single trailer assembly base to be flexibly converted into a number of different physical configurations, to allow the trailer to handle multiple different (perhaps seemingly incompatible) purposes, all while maintaining the structural strength and stability to allow the trailer to carry such trailer loads.

In one example, a module trailer may configured to support 3-in-1 modular optionality in a single trailer and include a flatbed base, a gear tub, and gear towers, including connection interfaces to allow these components to be detachably added and combined to adapt the trailer to various applications, use cases, and hauling configurations (including combinations thereof). A modular vehicle trailer may expand vehicle carrying capacity (e.g., beyond the storage capacity of the car or truck that is to pull the trailer) for versatile hauling options and experiences. The trailer may utilize a unique fully modular design to allow users to set up the trailer based on the user's multiple and changing needs for the trailer. The connection interfaces on the trailer and modular components may enable quick-release, modular trailering solutions. The trailer may be pulled by various vehicles including side-by-sides, UTVs, passenger vehicles, off-road vehicles, farm and ranch vehicles, emergency response vehicles, military vehicles, and so on. The modular towers, flatbed, and tub components may each be provided with one or multiple tracked or railed mounting systems or connection interfaces to implement the modular capabilities of the trailer. These mounting systems are integrated into the vehicle and may additionally allow an ecosystem of modules to be developed, which are compatible with the mounting system and facilitate the addition of additional accessories, tie-down points, wheel chocks, organization panels, recreational equipment (e.g., tents, stoves, etc.), among other components, which may be used to further customize the trailer's configuration in a modular manner.

In some implementations, the improved trailer may be constructed to be small, light, and nimble and towed to track behind smaller vehicles (e.g., below the minimum width for National Forest Service (NFS) trail access), such as side-by-side's, small tractors, and small passenger vehicles, among other examples. In other implementations, the trailer may incorporate the integrated mounting systems described herein and sized for use as a traditionally-sized trailer (e.g., wider than the acceptable width for NFS trail access), among other alternative implementations. The modularity and easy convertibility of the trailer may enable the trailer's use in a host of applications, such as carrying kayaks, canoes, surfboards, fishing equipment, hunting equipment, landscaping supplies and tools, rooftop tents, awnings, etc., which may be quickly stowed on the trailer or easily attached to the trailer's mounting tracks.

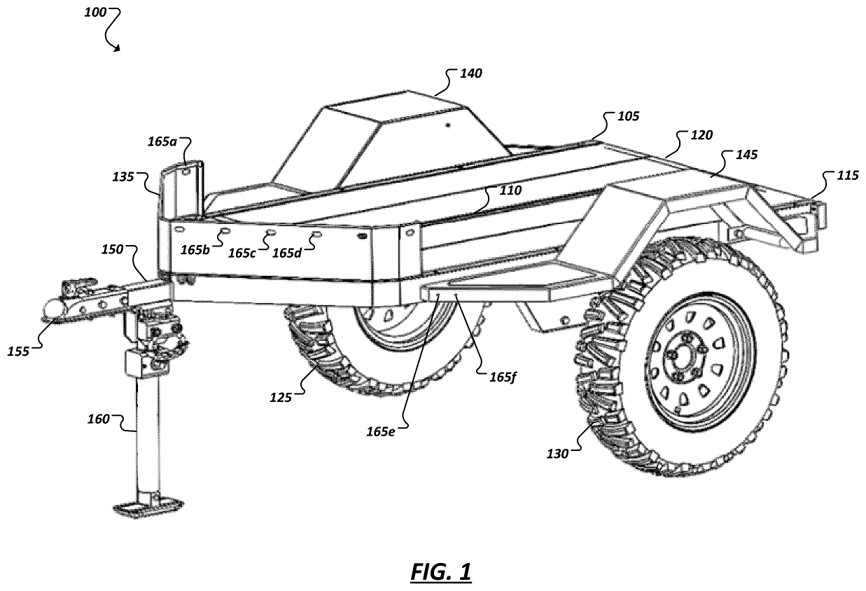

Turning to FIG. 1, a view of an example implementation of an improved modular trailer 100 is shown in a first configuration (e.g., a flatbed base configuration), with tower modules and tub module detached. The flatbed base may provide the foundation for the modular trailer and may represent a “default” or “base” orientation. This base foundation may feature multiple full-length channels that align with the connection points on the tub and tower and other components. As shown in this example, in one implementation, the flatbed base may include three attachment channels (e.g., 105, 110, 115) that extend the length of the bed 120 (e.g., one on each edge (e.g., 105, 115) and the third attachment channel (e.g., 110) serving as a center channel and running through the center of the bed 120). One or more (or all) of the attachment channels 105, 110, 115 may provide multiple suitable mounting locations for additional modular accessories such, which may be mounted at various locations along the length of the attachment channels, the modular accessories including such examples as tie-down points, wheel chocks, corner stops, mounting brackets, etc.

The trailer 100 may include additional components in accordance with the typical aspects of a trailer, including two (or four) wheels (e.g., 125, 130), corresponding fenders (e.g., 140, 145), a front barrier or wall 135 (e.g., to assist in containing contents carried on the bed 120, protecting contents carried on the bed, etc.), a trailer tongue (e.g., 150) and coupler (e.g., 155), and a jack (e.g., 160), among other example components. In some implementations, trailer components (e.g., 135, 140, 145, etc.) may be augmented to cofunction with the attachment channels (e.g., 105, 110, 115) and/or accessory modules attached to the connection points provided on the trailer 100. For instance, openings, hooks, or other features (e.g., 165a-d) may be provided on the front wall 135 or fenders (e.g., 140, 145) to enhance attachment opportunities provided on the trailer 100. Further, ratchet straps and other retention mechanisms may be compatible with the trailer's various attachment points to plug and play with the integrated mourning hardware used to couple the flatbed base, tub, and tower components. In one example, mounting hardware may include external and internal hex bolts, button bolts, hex nuts, eye bolts, quick-release leveraged latches, turnbuckles, thumbscrews, pinheads, torx, rubberized, antivibration, twist lock, spring lock, spring load, spring hook, self-tightening, and other example compression fitting components.

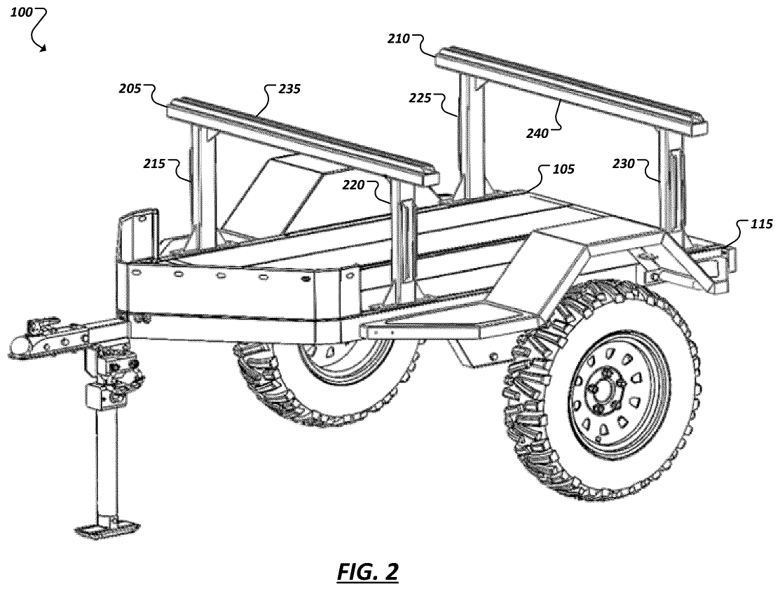

Turning to FIG. 2, the example trailer 100 of FIG. 1 is shown in a second, different orientation, with two tower modules (e.g., 205, 210) attached to the flatbed base of the trailer 100. A tower module (e.g., 205, 210) may include one or two leg segments (e.g., 215, 220, 225, 230) and a horizontal bridge segment (e.g., 235, 240). The towers (e.g., 205, 210) may function as “gear towers” that connect at the bottom of their leg segments to attachment channels (e.g., 105, 115) of the flatbed base 120 and secured via a bolt and nut or other connector (e.g., a compression fitting). In one example, a coupling at the bottom of each leg segment of the tower modules may be configured to mate, hook, or otherwise compliment the size and shape of the attachment channels (e.g., 105, 110, 115). The fittings or connector used to secure the couplings to the attachment channels may be simple to secure and unsecure allowing users to quickly and easily add or remove the tower modules to the trailer 100 and/or reposition tower modules along the length of the bed (and attachment channels) (e.g., by loosening the fitting and sliding the tower module along the length of the two attachment channels it is connected to) to adapt the trailer's configuration to specific desired needs of the user. The gear towers may be available in multiple height options. In other examples, the gear towers may include adjustable legs (or uprights) that allow the height of the tower (its horizontal bridge segment) to be adjusted. With the gear tower added to the flatbed base 120, the mounting options are potentially endless. Kayaks, surfboards, paddleboards, canoes, roof top tents, awnings, and more are easily supported by and attached to the towers through this modular interface.

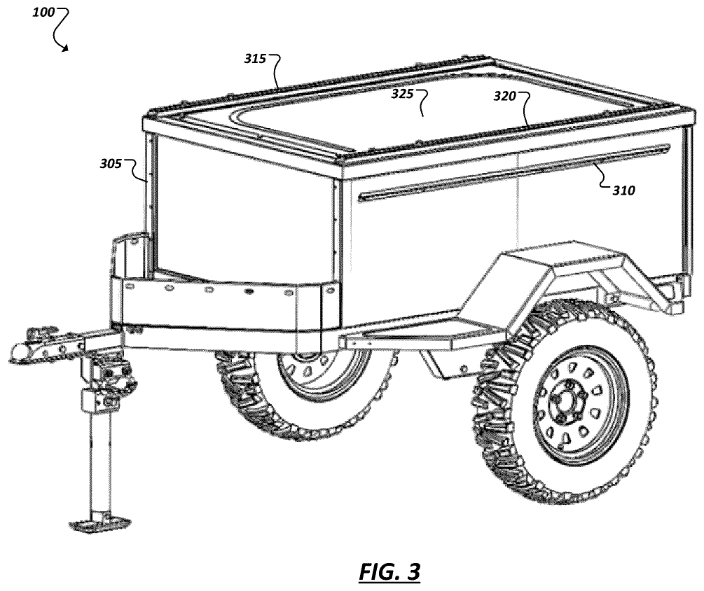

Turning to FIG. 3, the example of FIGS. 1 and 2 is shown in a third, different orientation, with a modular tub 305, or “gear tub”, module removably attached to the trailer base. The tub module 305, in this example, may include couplings configured to connect to two or more of the attachment channels provided on the bed of the trailer 100 (e.g., and secured to the channels via corresponding couplings (e.g., bolts/nuts, or other fittings) located on the bottom of the tub 305. In one example, the compression fitting is bolted through the frame of the tub 305. The tub 305, in some implementations, may feature a drop-down tailgate that extends the cargo capacity of the tub and flatbed. In some examples, the tub 305 has an open top allowing for larger items to exceed the height of the side walls of the tub. In some implementations, the tub module 305 may include attachment channels (e.g., 310, 315, 320, etc.) on the top and/or sides of the tub module walls to allow other modules to be attached to the top and/or sides of the tub module. The tub module 305 may also feature a removable cover (e.g., 325) to limit dirt, dust, and debris from entering the tub. In some implementations, attachment channels (e.g., 310, 315, 320) provided on the tub module 305 may be functionally and geometrically similar to the attachment channels integrated in the bed of the trailer 100, such that the same modules configured to attach to the bed's attachment channels may be just as suitably attached to the attachment channels (e.g., 310, 315, 320) of the tub module 305. In some implementations, the attachment channels (e.g., 310) may be provided on one or more (or each of the four) external walls of the tub module 305 to allow various modules to be attached to and carried on the side walls of the tub module 305, such as tables, sinks, boxes, cookstoves, fuel storage, firearm storage, etc., among other examples.

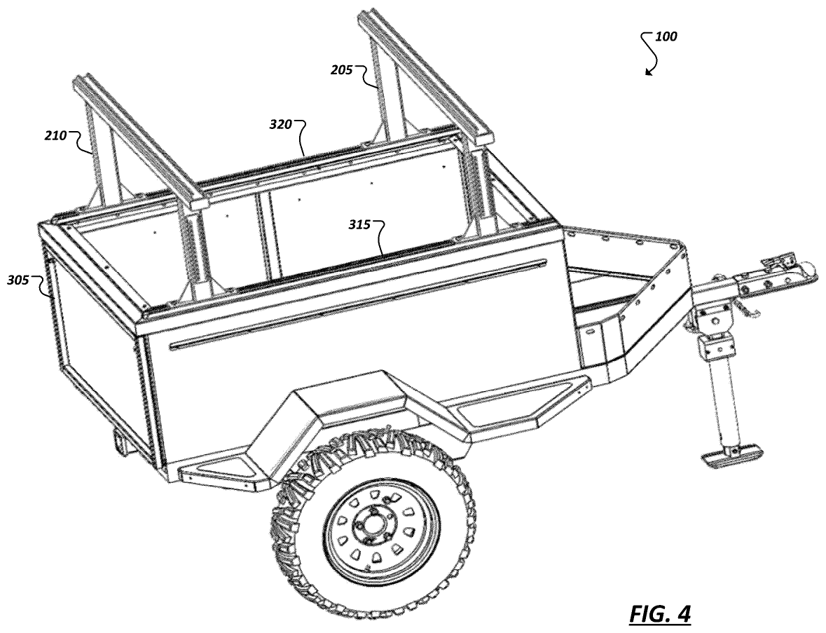

The tub component may also include an attachment channel on the top edges, or upper lips, of the tub modules. These attachment channels (e.g., 315, 320) may enable additional modules to be attached to the top of the tub module 305 (e.g., when it is attached to the flatbed base), including gear tower components. For instance, as shown in FIG. 4, the trailer system 100 of FIGS. 1-3 is show in a fourth configuration, with the tub module 305 mounted to the flatbed base (e.g., using the attachment channels on the flatbed base) and one or more gear tower modules (e.g., 205, 210) mounted to the top of the tub component using attachment channels or rails (e.g., 315, 320) positioned on the top edges of the tub 305. Each of the modules may be mounted to the other using similar couplings (e.g., implemented as bolted compression fittings) at respective attachment channels/rails. This module trailer system allows for independent operation of, or stacked operation of each individual component. In the flatbed base, gear tub, and gear tower configurations, the trailer components may be stacked on top of each other. For instance, in the example of FIG. 4, respective compression fittings/couplings located at the bottom of the tub module are used to couple to corresponding attachment channels of the flatbed base, and similar compression fittings located at the bottom of the legs of the tower modules are used to couple the tower modules to respective attachment channels (e.g., 315, 320) on the tub module to connect the tower modules to the tub module. Further, in some implementations, the bridge segments of one or more of the tower modules may also include similar attachment channels/rails to allow still other modules to be stacked on the trailer system by attaching to the tower modules, among other examples. As such, the trailer system including the trailer base, tub module, and one or more tower modules may provide an adaptable, customizable trailer system that offers a diverse array of orientations/configurations and further enables a diverse array of additional modular accessories compatible with the attachment channels/rails of the trailer system to be coupled to and further enhance the modular trailer system. It should be appreciated that still other example configurations may be implemented utilizing the modules of the trailer system, beyond those specifically shown in the examples of the FIGS. 1-4. As an example, the tub module, in some instances, may be connected to the top of the gear towers at attachment rails or channels provided on or recessed in the top of the bridge segment(s) of the tower module(s), among other examples.

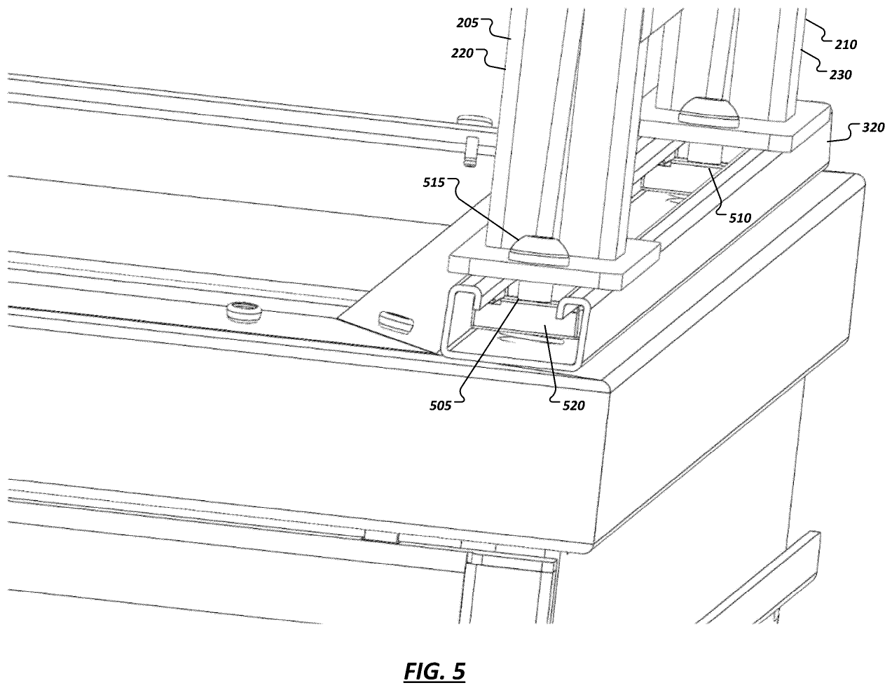

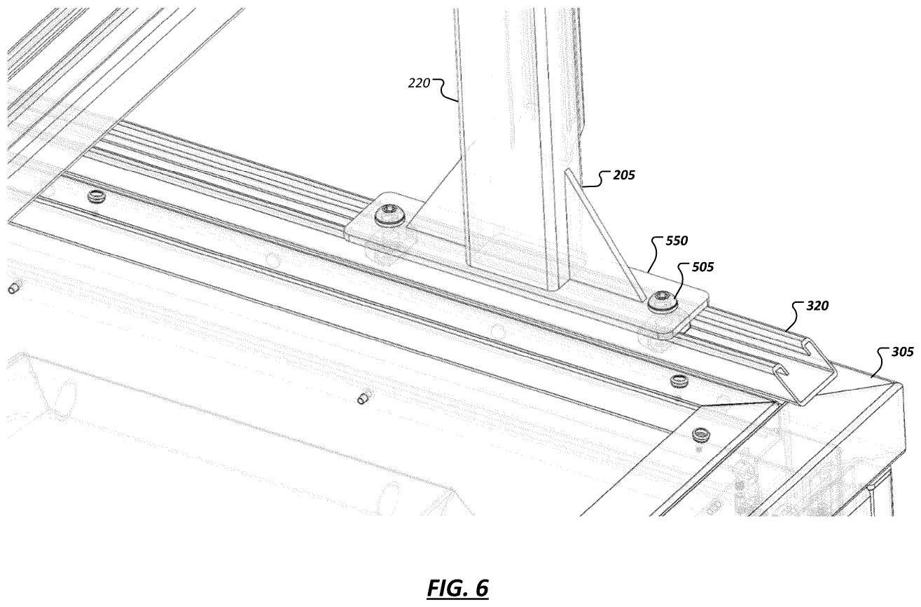

As introduced above, some modules compatible with an example module trailer system (e.g., as shown in the examples of FIGS. 1-4) may include couplings configured to securely (but removably) attached to attachment channels provided on the trailer base, tub module, and/or tower modules provided in the system. Turning to FIGS. 5-6, detailed views 500, 600 are presented to show details of an example implementation of an attachment rail (e.g., 320) together with an example implementation of corresponding couplings (e.g., 505, 510) configured to fit and secure to the specifical attachment rail configuration. (Attachment “channels” may include attachment “rails” (e.g., 320), which may be attachment channels (e.g., 105) implemented to sit above a top surface of the module (such as shown in the examples of FIGS. 5-6)). In this specific example, the attachment rail 320 is a rail positioned on the top of the tub module lip and the couplings (e.g., 505, 510) are couplings located at the bottoms of legs (e.g., 220, 230) of two tower modules (e.g., 205, 210). Similar coupling designs may be provided on the underside of the tub module to couple the tub module (e.g., 305) to two or more attachment channels on the trailer bed. In this specific example, couplings (e.g., 505, 510) are implemented as through bolt compression fittings (e.g., 505). More particularly, a bolt component (e.g., 515) is threaded through a block, tee, claw, or other nut component (e.g., 520) with a cross-sectional geometry aligned to fit or interlock with the geometry of the cross-sectional opening of the attachment channel/rail. The bolt component 515 passes through a surface or bracket (e.g., 550) (and potentially through one or more washers) of the module (e.g., 205) before being threaded through the nut component 520. Turning the bolt causes the nut component 520 to advance of the threading of the bolt and, through compression with one or more surface of the attachment channel/rail opening, secures the coupling within the attachment channel/rail (thereby connecting a module to the trailer bed or another trailer system module). These connections can be mechanically fastened with a number of different types of compression fittings. For instance, while Allen key-style bolts are shown in the examples of FIGS. 5-6, other alternatives may be suitably used, such as external and internal hex bolts, button bolts, hex nuts, eye bolts, quick-release leveraged latches, turnbuckles, thumbscrews, pinheads, torx, among other examples. In one example, the nut component (e.g., 520) may be implemented as a spring nut compressed in the channel/rail to retain the through bolt compression fitting, among other examples.

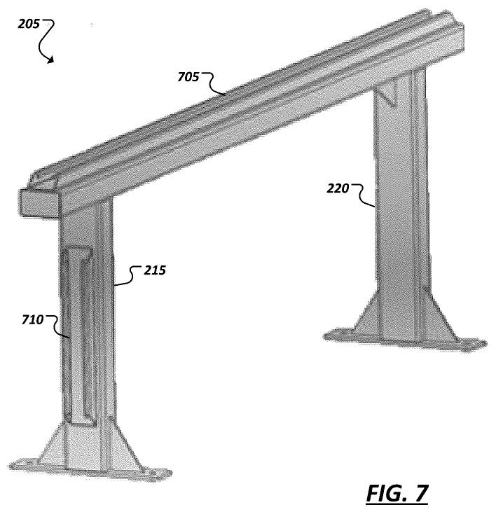

FIG. 7 illustrates an example gear tower module (e.g., 205) for inclusion in a modular trailer system. In this example, attachment rails or channels (or other connection mechanisms) may be provided on one or more outer surfaces of the tower module. In this example, the top horizonal bridge segment of the tower module may include a first attachment rail 705 and one or multiple additional vertical attachment rails (e.g., 710) provided on the vertical support legs (e.g., 215, 220) of the gear tower module to facilitate the attachment of a variety of modular accessories to the tower module, the modular accessories configured for use with and compatible with the attachment rails of the trailer system.

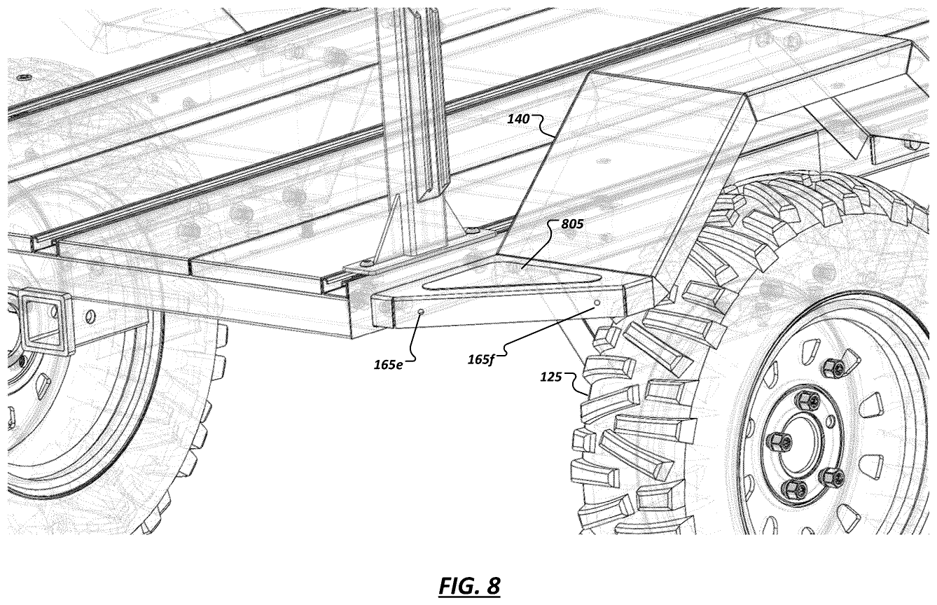

FIG. 8 shows an example of a fender element (e.g., 140) included in some implementations of the flatbed base of the improved trailer 100. For instance, each trailer tire (e.g., 125) may be housed within a structurally rated fender (e.g., 140) that allows users to stand or sit on the fender (using the fender as a step or seat). This provides a sturdy, flat surface for users to stand on while attaching or removing accessories. These surfaces also provide a solid mounting location (e.g., 805) for additional accessories such as propane tanks, water tanks, gasoline cans, etc. Each fender (e.g., 140) may also be equipped with indexed holes (e.g., 165e, 165f) for attaching items such as J hooks and other tie-down mechanisms, among other examples. In some implementations, the fender (e.g., 140) may be constructed of a fully structural bent tube understructure with sheet metal base, among other example implementations and features.

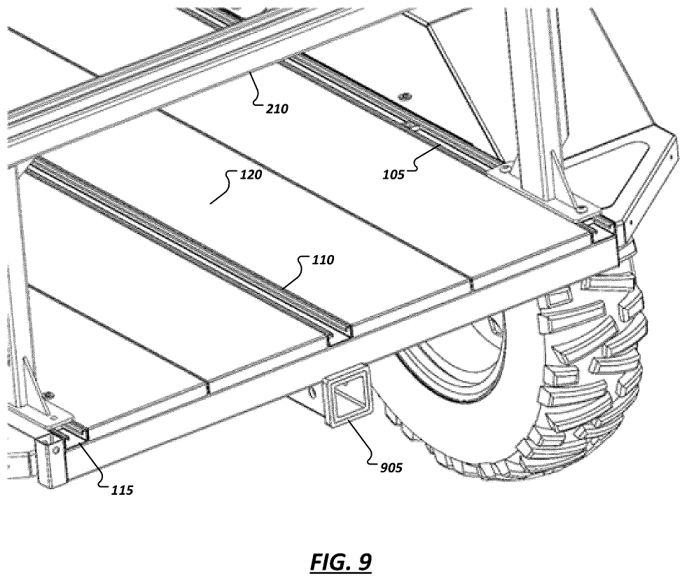

FIG. 9 shows a rear view of an example flatbed base 120 of an improved trailer, such as the example modular trailer system introduced and discussed in the preceding paragraphs and figures. As shown in the example of FIG. 9, a number of attachment channels (e.g., 105, 110, 115, etc.) are integrated with the flatbed base (e.g., to be recessed below the surface of the flatbed). The attachment channels may run the length of the trailer (e.g., parallel to the direction of travel of the trailer) and may have a geometry comparable to the attachment rail examples shown in the examples of FIGS. 5-6, such that modules with couplings configured for connection to the attachment rails of FIGS. 5-6 may be equally suitable for connecting to the attachment channels shown in the example of FIG. 9. Indeed, as in the example of FIGS. 5-6, the tower module 210 coupled to the tub module in FIG. 5 is coupled, in another orientation of the modular trailer system, to the flatbed base (e.g., using attachment channels 105, 115), where the tub module in FIG. 5 is coupled to the flatbed base using one or more of the attachment channels (e.g., 105, 110, 115) and is detached from the flatbed base 120 in the example orientation shown in FIG. 9. In some implementations, the flatbed base 120 may include additional features, such as a receiver hitch 905 (e.g., a 2″ receiver hitch) to provide an accessory hitch attachment point for items such as cargo baskets, bike racks, motorcycle trays, extension poles, boom lifts, and more. The integrated receiver tube 905 may feature a centered placement for an additional recovery point, among other example features.

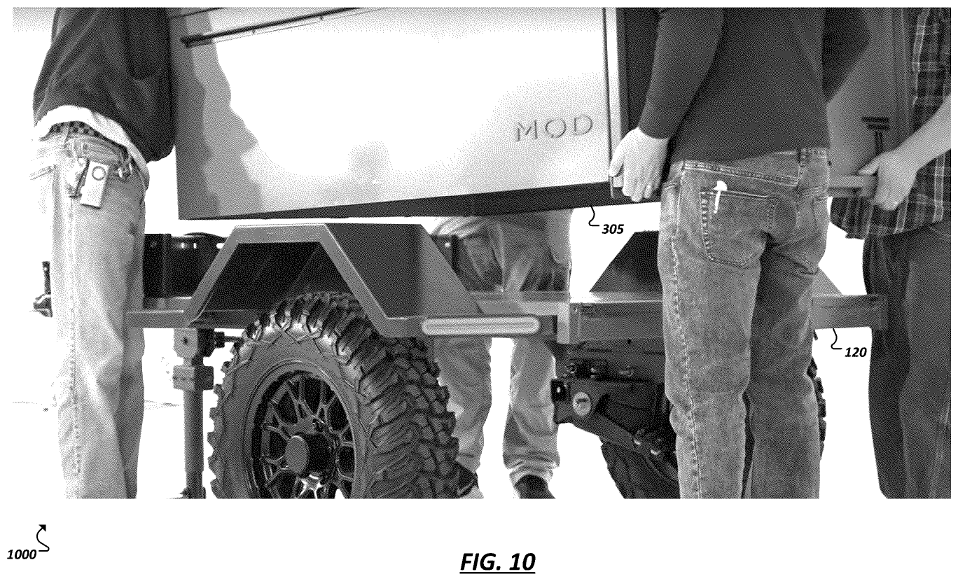

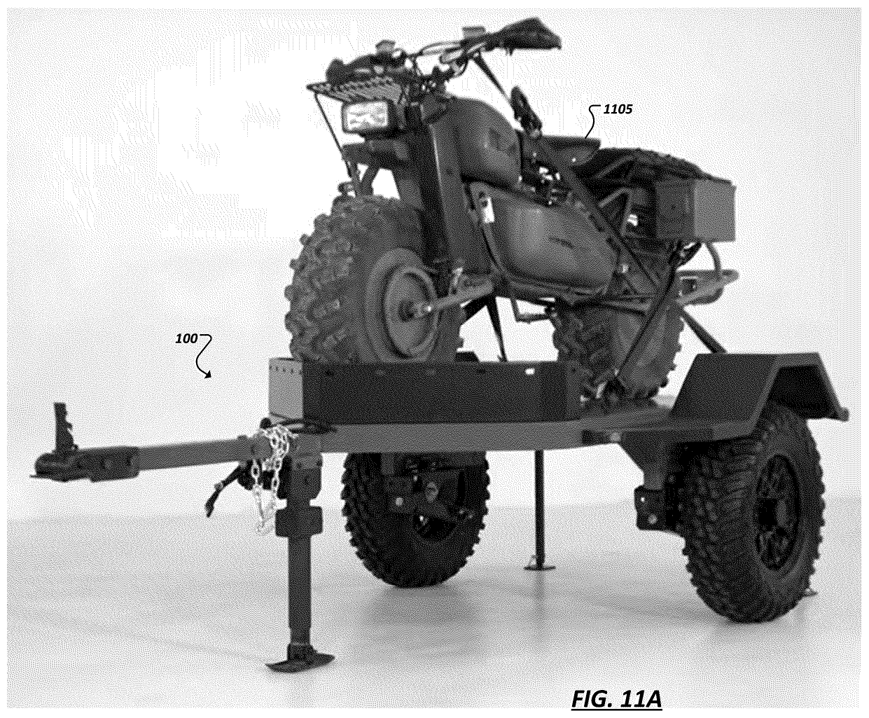

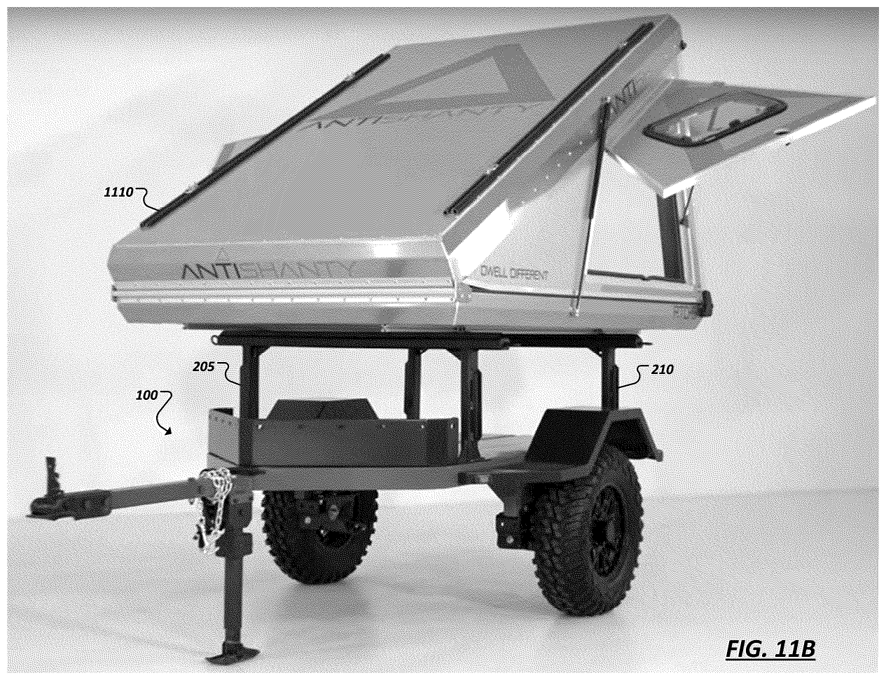

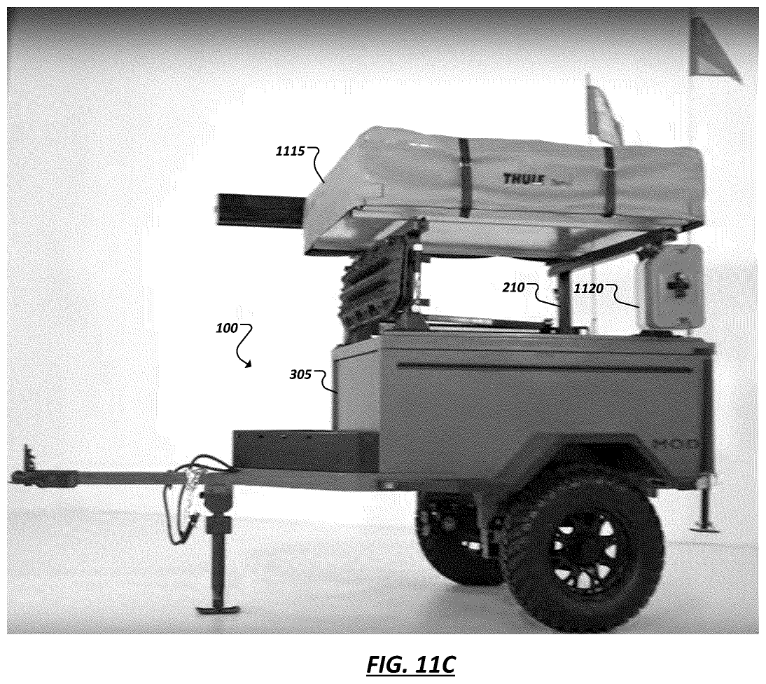

FIG. 10 is a photo 1000 illustrating the example mounting (or unmounting) of a tub module 305 onto an example flatbed base 120 component, demonstrating the modularity and convertibility of an example modular trailer system. The flexibility provided through a modular trailer system enables a variety of configurations, which may be leveraged in a variety of different applications, such as those shown in the examples of FIGS. 11A-11C. For instance, FIG. 11A shows a flatbed-only orientation (e.g., with tie point components and wheel chock components connected to the attachment channels of the flatbed base) enabling the trailer system 100 to be used for hauling a small vehicle 1105 (e.g., a motorcycle) or other cargo. FIG. 11B shows the same trailer system 100 converted into a gear tower-on-flatbed configuration, allowing items or components (e.g., with footprints wider than the flatbed base) to be hauled or carried on top of the gear tower horizontal bridge supports. In the example of FIG. 11B, a rooftop tent module 1110 is carried on top of and coupled to the top of the tower modules (e.g., 205, 210). FIG. 11C shows the same trailer system 100 converted into yet another modular configurations, such as a tub module with gear tower configuration, allowing a variety of equipment to be hauled using the trailer system, including items within the tub module 305, items 1115 (e.g., a carrier, luggage, or other module) on top horizontal supports of the gear towers 205, 210, and items 1120 (e.g., a rack, fuel or water container, or other module) mounted on the vertical supports of the gear towers, among other example components, configurations, and applications.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results.

The following examples pertain to embodiments in accordance with this Specification. Example 1 is a trailer including: a flatbed base including: at least two wheels; a trailer tongue; a plurality of attachment channels, where each attachment channel in the plurality of attachment channels has an opening with a cross-section adapted to a particular coupling geometry; a detachable tub component including a set of tub couplings on a bottom surface of the detachable tub component, where tub couplings in the set of tub couplings have the particular coupling geometry and at least a subset of the set of tub couplings are configured to securely and removably couple the tub component to one or more of the plurality of attachment channels to couple the tub component to the flatbed base; and a detachable tower component including: a horizontal bridge support; and at least one upright support leg, where the at least one upright support leg includes a tower coupling, where the tower coupling has the particular coupling geometry and is to securely and removably couple the tower component to one or more of the plurality of attachment channels to couple the tower component to the flatbed base.

Example 2 includes the subject matter of example 1, where the flatbed base includes a flatbed positioned between the at least two wheels, and the plurality of attachment channels are attached to the flatbed.

Example 3 includes the subject matter of example 2, where the plurality of attachments channels are mounted to be flush or below a top surface of the flatbed.

Example 4 includes the subject matter of example 3, where the plurality of attachment channels include a first attachment channel adjacent to a first edge of the flatbed, a second attachment channel parallel to the first attachment channel and adjacent to a second edge of the flatbed, and a third attachment channel parallel to and between the first and second attachment channels.

Example 5 includes the subject matter of any one of examples 1-4, where the tub component further one or more attachment channels mounted to one or more surfaces of the tub component, where the one or more attachment channels mounted to the tub component have openings with cross-sections adapted to the particular coupling geometry.

Example 6 includes the subject matter of example 5, where the one or more attachment channels mounted to one or more surfaces of the tub component include a first attachment channel mounted on a top surface of a first rim of the tub component and a second attachment channel mounted on a top surface of a second rim of the tub component, where the tower component is adapted to be coupled to the top of the tub component at the first and second attachment channels using the tower coupling.

Example 7 includes the subject matter of example 6, where the one or more attachment channels mounted to one or more surfaces of the tub component further include a third attachment channel mounted to a side wall of the tub component.

Example 8 includes the subject matter of any one of examples 6-7, where the tower component includes one or more attachment channels mounted to one or more surfaces of the horizontal bridge support or the at least one upright support leg of the tower component, and the one or more attachment channels mounted to the tower component have openings with cross-sections adapted to the particular coupling geometry.

Example 9 includes the subject matter of any one of examples 1-8, where the tower component includes one or more attachment channels mounted to one or more surfaces of the horizontal bridge support or the at least one upright support leg of the tower component, and the one or more attachment channels mounted to the tower component have openings with cross-sections adapted to the particular coupling geometry.

Example 10 includes the subject matter of example 9, where the one or more attachment channels mounted to the tower component includes a horizontal attachment channel mounted at a top surface of the horizontal bridge support.

Example 11 includes the subject matter of example 10, where the tower component includes a first tower component and the trailer includes a second detachable tower component, the second tower component includes another horizontal attachment channel mounted at a top surface of the second detachable tower component, where the set of tub couplings are adapted to couple to the horizontal attachment channel and the second horizontal attachment channel to connect the tub component to and support the tub component by the first tower component and the second tower component.

Example 12 includes the subject matter of any one of examples 9-11, where the tower component further includes two upright support legs, and the two upright support legs include respective ones of the attachment channels mounted to the tower component.

Example 13 includes the subject matter of any one of examples 1-12, where the set of tub couplings or the tower coupling include a compression fitting.

Example 14 includes the subject matter of example 13, where the compression fitting includes a nut and a bolt, and the bolt has the particular coupling geometry.

Example 15 includes the subject matter of any one of examples 1-14, where the flatbed base includes a fender positioned above one of the two or more wheels and configured to bear the weight of a human user.

Example 16 includes the subject matter of example 15, where the fender includes one or more component attachment means.

Example 17 is a system including: a trailer including: at least two wheels; a trailer tongue; a flatbed base including a plurality of attachment channels, where each attachment channel in the plurality of attachment channels has an opening with a cross-section adapted to a particular coupling geometry; a detachable tub component including a set of tub couplings on a bottom surface of the detachable tub component, where tub couplings in the set of tub couplings have the particular coupling geometry and at least a subset of the set of tub couplings are configured to securely and removably couple the tub component to one or more of the plurality of attachment channels to couple the tub component to the flatbed base; and a detachable tower component including: a horizontal bridge support; and at least one upright support leg, where the at least one upright support leg includes a tower coupling, where the tower coupling has the particular coupling geometry and is to securely and removably couple the tower component to one or more of the plurality of attachment channels to couple the tower component to the flatbed base.

Example 18 includes the subject matter of example 17, further including a set of accessories, where each accessory in the set of accessories includes a respective coupling with the particular coupling geometry adapted to allow the accessory to be securely and removably coupled to one of the plurality of attachment channels.

Example 19 includes the subject matter of example 18, where the set of accessories includes at least one of a tent component, a stove component, a container component, or a rack component.

Example 20 includes the subject matter of any one of examples 18-19, where at least one of the tower component or the tub component includes an additional attachment channel with an opening with a cross-section adapted to the particular coupling geometry and adapted to couple to the couplings of the set of accessories.

Example 21 includes the subject matter of any one of examples 17-20, where the tub component includes the tub component in any one of examples 1-16

Example 22 includes the subject matter of any one of examples 17-20, where the tower component includes the tower component in any one of examples 1-16.

Example 23 includes the subject matter of any one of examples 17-22, further including a second tower component.

Example 24 is an apparatus including the tub component in any one of examples 1-16.

Example 25 is an apparatus including the tower component in any one of examples

1-16.

A detailed description has been given with reference to specific exemplary embodiments. It will, however, be evident that various modifications and changes may be made thereto without departing from the broader spirit and scope of the invention as set forth in the appended claims. The specification and drawings are, accordingly, to be regarded in an illustrative sense rather than a restrictive sense. Furthermore, the foregoing use of embodiment and other exemplarily language does not necessarily refer to the same embodiment or the same example, but may refer to different and distinct embodiments, as well as potentially the same embodiment.

1. A trailer comprising:
a flatbed base comprising:
at least two wheels;
a trailer tongue;
a plurality of attachment channels, wherein each attachment channel in the plurality of attachment channels has an opening with a cross-section adapted to a particular coupling geometry;
a detachable tub component comprising a set of tub couplings on a bottom surface of the detachable tub component, wherein tub couplings in the set of tub couplings have the particular coupling geometry and at least a subset of the set of tub couplings are configured to securely and removably couple the tub component to one or more of the plurality of attachment channels to couple the tub component to the flatbed base; and
a detachable tower component comprising:
a horizontal bridge support; and
at least one upright support leg, wherein the at least one upright support leg comprises a tower coupling, wherein the tower coupling has the particular coupling geometry and is to securely and removably couple the tower component to one or more of the plurality of attachment channels to couple the tower component to the flatbed base.

2. The trailer of claim 1, wherein the flatbed base comprises a flatbed positioned between the at least two wheels, and the plurality of attachment channels are attached to the flatbed.

3. The trailer of claim 2, wherein the plurality of attachments channels are mounted to be flush or below a top surface of the flatbed.

4. The trailer of claim 3, wherein the plurality of attachment channels comprise a first attachment channel adjacent to a first edge of the flatbed, a second attachment channel parallel to the first attachment channel and adjacent to a second edge of the flatbed, and a third attachment channel parallel to and between the first and second attachment channels.

5. The trailer of claim 1, wherein the tub component further one or more attachment channels mounted to one or more surfaces of the tub component, wherein the one or more attachment channels mounted to the tub component have openings with cross-sections adapted to the particular coupling geometry.

6. The trailer of claim 5, wherein the one or more attachment channels mounted to one or more surfaces of the tub component comprise a first attachment channel mounted on a top surface of a first rim of the tub component and a second attachment channel mounted on a top surface of a second rim of the tub component, wherein the tower component is adapted to be coupled to the top of the tub component at the first and second attachment channels using the tower coupling.

7. The trailer of claim 6, wherein the one or more attachment channels mounted to one or more surfaces of the tub component further comprise a third attachment channel mounted to a side wall of the tub component.

8. The trailer of claim 6, wherein the tower component comprises one or more attachment channels mounted to one or more surfaces of the horizontal bridge support or the at least one upright support leg of the tower component, and the one or more attachment channels mounted to the tower component have openings with cross-sections adapted to the particular coupling geometry.

9. The trailer of claim 1, wherein the tower component comprises one or more attachment channels mounted to one or more surfaces of the horizontal bridge support or the at least one upright support leg of the tower component, and the one or more attachment channels mounted to the tower component have openings with cross-sections adapted to the particular coupling geometry.

10. The trailer of claim 9, wherein the one or more attachment channels mounted to the tower component comprises a horizontal attachment channel mounted at a top surface of the horizontal bridge support.

11. The trailer of claim 10, wherein the tower component comprises a first tower component and the trailer comprises a second detachable tower component, the second tower component comprises another horizontal attachment channel mounted at a top surface of the second detachable tower component, wherein the set of tub couplings are adapted to couple to the horizontal attachment channel and the second horizontal attachment channel to connect the tub component to and support the tub component by the first tower component and the second tower component.

12. The trailer of claim 9, wherein the tower component further comprises two upright support legs, and the two upright support legs comprise respective ones of the attachment channels mounted to the tower component.

13. The trailer of claim 1, wherein the set of tub couplings or the tower coupling comprise a compression fitting.

14. The trailer of claim 13, wherein the compression fitting comprises a nut and a bolt, and the bolt has the particular coupling geometry.

15. The trailer of claim 1, wherein the flatbed base comprises a fender positioned above one of the two or more wheels and configured to bear the weight of a human user.

16. The trailer of claim 15, wherein the fender comprises one or more component attachment means.

17. A system comprising:
a trailer comprising:
at least two wheels;
a trailer tongue;
a flatbed base comprising a plurality of attachment channels, wherein each attachment channel in the plurality of attachment channels has an opening with a cross-section adapted to a particular coupling geometry;
a detachable tub component comprising a set of tub couplings on a bottom surface of the detachable tub component, wherein tub couplings in the set of tub couplings have the particular coupling geometry and at least a subset of the set of tub couplings are configured to securely and removably couple the tub component to one or more of the plurality of attachment channels to couple the tub component to the flatbed base; and
a detachable tower component comprising:
a horizontal bridge support; and
at least one upright support leg, wherein the at least one upright support leg comprises a tower coupling, wherein the tower coupling has the particular coupling geometry and is to securely and removably couple the tower component to one or more of the plurality of attachment channels to couple the tower component to the flatbed base.

18. The system of claim 17, further comprising a set of accessories, wherein each accessory in the set of accessories comprises a respective coupling with the particular coupling geometry adapted to allow the accessory to be securely and removably coupled to one of the plurality of attachment channels.

19. The system of claim 18, wherein the set of accessories comprises at least one of a tent component, a stove component, a container component, or a rack component.

20. The system of claim 18, wherein at least one of the tower component or the tub component comprises an additional attachment channel with an opening with a cross-section adapted to the particular coupling geometry and adapted to couple to the couplings of the set of accessories.
